(19) United States
(12) Patent Application Publication
(10) Pub. No.: US 2024/0328939 A1
(43) Pub. Date: Oct. 3, 2024

(54) METHOD AND SYSTEM FOR ANALYSING A SAMPLE BASED ON DATA

(71) Applicant: SENORICS GMBH, Dresden (DE)

(72) Inventors: Tom LANDGRAF, Dresden (DE); Robert BRÜCKNER, Dresden (DE)

(73) Assignee: SENORICS GMBH, Dresden (DE)

(21) Appl. No.: 18/579,745

(22) PCT Filed: Jul. 18, 2022
(86) PCT No.: PCT/EP2022/070046

§ 371 Date: Jan. 16, 2024

(30) Foreign Application Priority Data
Jul. 19, 2021 (DE) 10 2021 118 559.9

(51) Int. Cl. G01N 21/359

(52) U.S. Cl. CPC G01N 21/359; G01N 2201/129

(57) ABSTRACT

The invention relates to a method for analyzing a sample based on data generated by a measuring instrument divided into N channels. The method the following method steps: i. acquiring measurement data y(x) with at least one set of the N channels of the measuring instrument in a range of x overlapping between the selected channels; ii. selecting a value xⱼ from the overlapping range of x; iii. determining coefficients quantifying the respective share of the selected channels in the total response yₜₒₜ(xⱼ) recorded at xⱼ; and iv. repeating steps ii. and iii. for M values (I).

The invention relates to a method for analyzing a sample from data generated by a measuring instrument divided into N channels, a computer-implemented method, an associated data processing device and an associated computer program product, and a system for analyzing a sample comprising a measuring instrument divided into N channels for generating data of the sample and a data processing device connected to the measuring instrument via a communication link, wherein the data processing device performs the method for analyzing a sample from data.

Near-infrared spectroscopy (NIR spectroscopy) is an optical measurement method that allows the identification, differentiation, and quantification of substances in gaseous, liquid, or solid compositions.

The analysis of spectral data in the NIR wavelength range, i.e. at wavelengths A from approx. 350 nm to approx. 2500 nm, requires complex calculation algorithms due to the strong superposition of the absorption bands of the substances, which are often described with the general keyword “chemometrics”. These algorithms work on the basis of statistical methods. Using methods such as multivariate linear regression, principal component analysis or support vector machines, the measured spectral data can be correlated with chemical variables, such as the concentration of a substance, or unknown substances can be identified. The algorithms must be trained on the basis of measurement data (which can also be generated artificially) of known pure substances and mixtures in order to be able to deliver the relevant variables. The mapping between spectral data and the chemical quantities sought is known as chemometric calibration.

There are several reasons why a chemometric calibration created with a specific, first measuring instrument cannot easily predict the spectra of another, second measuring instrument. For example, two identical measuring instruments from the same batch may have such large design-related deviations that it is not possible to transfer the chemometric calibration from one measuring instrument to the other without correction. However, the ageing or readjustment of a measuring instrument can also lead to a calibration algorithm that has already been created having to be modified.

For this purpose, a calibration transfer is performed, which should ideally allow a chemometric calibration to be transferred from one instrument to another with statistically unvarying accuracy.

A frequently used approach to calibration transfer is referred to as “Piecewise Direct Standardization” (PDS). The basis of PDS is to relate a reference point at a wavelength in the spectrum of the first measuring instrument to a wavelength range in the spectrum of the second measuring instrument around the reference point. A linear regression of the sampling point at a wavelength in the spectrum of the first measuring instrument to the wavelength range in the spectrum of the second measuring instrument results in a regression model for each sampling point. The regression vectors can be summarized in a transfer matrix, by means of which the transferred spectrum can be obtained from the original spectrum.

For example, U.S. Pat. No. 5,459,677 B1 describes a method for transferring a chemometric calibration model from a reference instrument to a target instrument. The method involves measuring transfer samples with the reference instrument to generate a reference instrument response for each transfer sample. These measurements are repeated with the target instrument, recording a target instrument response for each transfer sample. Transfer coefficients are then generated, which can be used to make a multivariate estimate of the reference instrument response from the target instrument response, whereby the mapping is carried out for the entirety of the transfer samples. Using these transfer coefficients, the reference instrument response for an unknown sample can then be estimated from the target instrument response for this sample.

DE 44 34 168 A1 relates to a colorimeter with which the spectral distribution of a radiation can be completely detected without filters or gratings. In the active version, the invention comprises, for example, a light source and a number m of sensors with different spectral characteristics. The sensors must be linearly independent of each other and detect the wavelength range to be covered in overlap. To calibrate the device, it must be used to measure a set of m calibration standards with known reflection characteristics in succession in order to form m calibration functions, i.e., each of the m calibration standards is illuminated with the light source and the intensity of the reflected light is measured with each of the m sensors. To evaluate the calibration, a system of equations is formed in which the known reflection characteristic of each calibration standard is related to the measured intensity of all sensors by means of calibration coefficients. When measuring an unknown object, these calibration coefficients are used to convert the measured intensity at a specific reference point, at which calibration coefficients are defined, into the true intensity.

A particular disadvantage of this device and the associated calibration is that calibration standards must be used, and measurement uncertainties are mapped directly in the coefficients. Measuring instruments, such as spectrometers, which acquire measurement data y for analyzing a sample as a function of a specific parameter x, e.g. an intensity of electromagnetic radiation influenced by interaction with the sample as a function of the wavelength of the electromagnetic radiation, can be divided into a number N of channels, each of the N channels preferably acquiring the measurement data y in a specific range of x or at a specific x, but also being suitable for acquiring y in a range of x or at a specific x, which is assigned to another channel.

For example, a spectrometer may be divided into N channels, each of the N channels having a filter that allows a particular wavelength range to pass preferentially or has greater sensitivity in a particular wavelength range than in other wavelength ranges, the wavelength ranges in which the channels contribute to the overall response of the spectrometer overlapping at least partially between the channels.

EP 3 152 785 B1 discloses an organic photodetector (OPD) that is suitable for detecting electromagnetic radiation in the NIR wavelength range of the electromagnetic spectrum. In the OPD described, the photoactive layer is arranged between two mirror surfaces, e.g. two electrodes with reflective surfaces facing each other, thereby forming an optical microcavity. For electromagnetic waves with a wavelength that fulfills the resonance condition of the optical microcavity, standing waves are formed in the microcavity. The EQE of the OPD is significantly increased for such a wavelength. Typically, the resonance condition of an optical cavity designed as a Fabry-Pérot cavity is fulfilled if the following applies to its optical length n·L: n·L=(i·λᵢ·cos α)/2, where n is the effective refractive index over the physical length L of the cavity, which, neglecting the penetration depth of the electromagnetic field into the material comprising the mirror surfaces, corresponds to the distance between the mirror surfaces, i is the order of the standing wave that forms, λᵢ is the wavelength of the incident wave and a is the angle of incidence of the incident wave with respect to a direction parallel to the physical length L of the cavity. If the irradiation of the cavity is parallel to the physical length L (α=0), the resonance condition is fulfilled if the optical path length of the cavity is an integer multiple of half the wavelength of the incident wave. In reality, incident waves with wavelengths in a range around the wavelength for which the above-mentioned resonance condition applies are amplified by the cavity. Thus, compared with an OPD with a corresponding photoactive layer that is not arranged in a microcavity, the EQE of the OPD with a microcavity is increased when the optical path length between the mirror surfaces of the microcavity is 25% to 75% of the wavelength of the incident wave. In the following, the term “resonant wavelength” is used for the wavelength at which the resonance condition of the microcavity is fulfilled and the EQE is maximized.

Advantageously, the resonance wavelength can be varied by varying the distance between the mirror surfaces. In this way, a spectrometer for detecting electromagnetic radiation in an extended wavelength range can be provided with the aid of a sequence of a number N of OPDs of the type described with increasing optical lengths of the respective cavity of the OPD. Each OPD has a resonance wavelength corresponding to the optical length of its cavity and corresponds to a channel of the spectrometer, so that the spectrometer has N channels.

According to the state of the art, during a measurement over the extended wavelength range of the spectrometer, the entire signal recorded with one channel of the spectrometer is integrated and assigned to the resonance wavelength of the OPD constituting the channel. Accordingly, a measurement series recorded with the spectrometer comprises N individual values.

Two aspects in particular are problematic about this approach: Firstly, spectral information contained in the signal of a channel is lost due to the integration of the signal and the assignment to the nominal resonance wavelength, and at the same time there is a mixture of the information assigned to different wavelengths. On the other hand, the actual resonance wavelength of a specific channel of a first measuring instrument and the actual resonance wavelength of a specific channel of a second measuring instrument with approximately the same nominal resonance wavelength can differ from each other, which complicates the transfer of the chemometric calibration from one measuring instrument to the other. The same applies to the transfer of a chemometric calibration generated on a reference spectrometer at specific, fixed wavelengths.

To overcome the disadvantages of the prior art, a method for analyzing a sample from data generated by a measuring instrument divided into N channels is proposed, comprising the following method steps:
i. Acquiring measurement data y(x) with at least one set of the N channels of the measuring instrument in a range of x overlapping between the selected channels;
ii. Selecting a value xⱼ from the overlapping range of x;
iii. Determining coefficients quantifying the respective share of the selected channels in the total response yₜₒₜ(xⱼ) recorded at xⱼ;
iv. Repeating steps ii. and iii. for M values {xⱼₘ}ₘ₌₁^{M}.

In one embodiment of the method according to the invention, the following method step is performed after method steps i. to iv.:
v. Creating the coefficient matrix containing the coefficients determined in steps iii. and iv. for unmixing the shares of the selected channels in the total response.

In that, x is the variable as a function of which the measurement signal y (the response) of a channel is measured. The total response yₜₒₜ(xⱼ) is made up of the values for y generated by the selected channels at xⱼ.

The selection of channels to be used to determine the coefficients must be made in such a way that all channels are included in which information is contained at the value xᵢ, i.e., all channels in which y(xᵢ) makes a significant contribution to yₜₒₜ(xⱼ). Using the method according to the invention, partial spectra can also be analyzed for specific applications.

For example, the least squares method (LSQ, e.g. bounded NNLSQ) can be used to determine the coefficients.

The coefficients are generalized coefficients that are not subject to any assignment to specific samples, e.g. calibration standard samples.

Preferably, x is the wavelength of electromagnetic radiation, particularly preferably in the NIR range. y can be, for example, a current, an intensity, the EQE, etc. In this preferred embodiment, the method can also be referred to as “spectral unmixing”.

The method according to the invention can be applied to an arrangement of OPDs with increasing resonance wavelengths, e.g. for spectral unmixing of the EQE of the individual OPDs.

The person skilled in the art knows that the matrix-vector product is only determined if the number of columns of the coefficient matrix and the number of components of the vector with which the matrix is multiplied are equal. The number of components of the product corresponds to the number of rows of the matrix.

For the method according to the invention, this means that the matrix is, for example, an M×N matrix, i.e., it has M rows and N columns, where M can be less than or greater than N, or M=N.

The number of columns of the coefficient matrix and the number of components of the vector by which the coefficient matrix is multiplied can be increased beyond the number of channels of the measuring instrument, e.g. by including measurement data y(x) determined with the same measuring instrument for a second, third, etc. sample that is different from the first sample.

The values xj are freely selected from the entire range of x measured with each channel. In this sense, the xj distributed over the entire measured range can be equally spaced apart, or the spacing between a first and a second xj differs from the spacing between the second and a third xj. Expediently, the xj can be spaced closer together, for example, in a range of x in which the measurement signal contains a lot of information than in a range of x which contains less information.

The method according to the invention is therefore suitable for increasing the number of individual values of a measurement series generated with the measuring instrument, e.g. beyond the number of channels of the measuring instrument. This can be seen as an advantageous increase in the resolution of a measurement with respect to x.

The method according to the invention advantageously simplifies the application of calibration models which have been created from literature data for the measurements to be analyzed, e.g. spectra, or of calibration models which have been created from measurements not recorded with the measuring instrument and which may have a resolution with respect to x different from the resolution of the measuring instrument, to the data recorded with the measuring instrument. The same applies to measurements that have been recorded with different measuring instruments of the same batch, but which differ from each other in terms of x, e.g. because the resonance wavelengths of a channel kj differ in a first and a second measuring instrument. In this case, a particular advantage of the method according to the invention is that the coefficients or the coefficient matrix are determined, for example, with the first measuring instrument, and only the determined coefficients or the coefficient matrix are then stored on the second measuring instrument (and correspondingly further measuring instruments) of the same series and can be used for unmixing the data recorded with the second measuring instrument. The coefficients or the coefficient matrix therefore do not have to be determined with each of the measuring instruments in a batch, but can be implemented on other instruments once they have been determined on a “reference instrument”.

Advantageously, the measurement data acquisition does not have to be performed on calibrated standard samples, but is performed on a selection of samples to be analyzed which is optimized, for example, with respect to the avoidance of local linear dependencies. A further aspect of the invention relates to a computer-implemented method for analyzing a sample using data generated by a measuring instrument which is divided into N channels, wherein the computer-implemented method comprises at least the following method steps:
a. Providing measurement data y(x) measured with at least one selection of the N channels of the measurement instrument in a range of x overlapping between the selected channels;
b. Selecting a value xⱼ from the overlapping range of x;
c. Determining coefficients quantifying the respective share of the selected channels in the total response yₜₒₜ(x_{j,m}) recorded at x_{j,m};
d. Repeating steps b. and c. für M values {x_{j,m}}ₘ₌₁^{M}.

In one embodiment, the computer-implemented method further comprises the following method step:
e. Creating the coefficient matrix containing the coefficients determined in steps c. and d. for unmixing the shares of the selected channels in the total response.

A further aspect of the invention relates to a data processing apparatus comprising means for carrying out the computer-implemented method.

Furthermore, the invention also relates to a computer program product comprising instructions which, when the program is executed by a computer, cause the computer to perform the computer-implemented method.

Another aspect of the invention relates to a system for analyzing a sample, comprising a measuring instrument divided into N channels for acquiring data of the sample and a device for data processing which is connected to the measuring instrument via a communication link, wherein the system performs the method according to the invention for analyzing a sample from data according to steps i. to iv. or to v. or the computer-implemented method according to steps a. to d. or to e., respectively.

In one embodiment of the system, the measuring instrument is a spectrometer, so that x corresponds to the wavelength of the electromagnetic radiation.

By no longer tying the transmission of a calibration of a measurement instrument to a particular value x associated with a channel, e.g. the resonant wavelength of a channel, the various aspects of the invention also particularly advantageously allow analysis services to be provided on behalf of a plurality of customers using a plurality of measurement instruments connected to a centralized data processing device, e.g. a processor, having loaded therein at least one calibration model configured to generate a predicted result of a property of interest from measurement data acquired from a plurality of samples using the measurement instruments, wherein providing analytical services comprises transmitting the predicted value of the property of interest to a customer for whom analytical services are required for a particular sample of a material.

For the sake of brevity, the term “at least one” is used in this description, which can mean: one, exactly one, several (e. g. exactly two, or more than two), many (e.g. exactly three or more than three), etc. In this context, “several” or “many” does not necessarily mean that there are several or many identical elements, but several or many essentially functionally identical elements.

The invention is not limited to the embodiments shown and described, but also includes all embodiments having the same effect in the sense of the invention. Furthermore, the invention is also not limited to the specifically described combinations of features, but can also be defined by any other combination of certain features of all the individual features disclosed as a whole, provided that the individual features are not mutually exclusive or a specific combination of individual features is not explicitly excluded.

The invention is explained below by means of embodiments with reference to figures, without being limited to these.

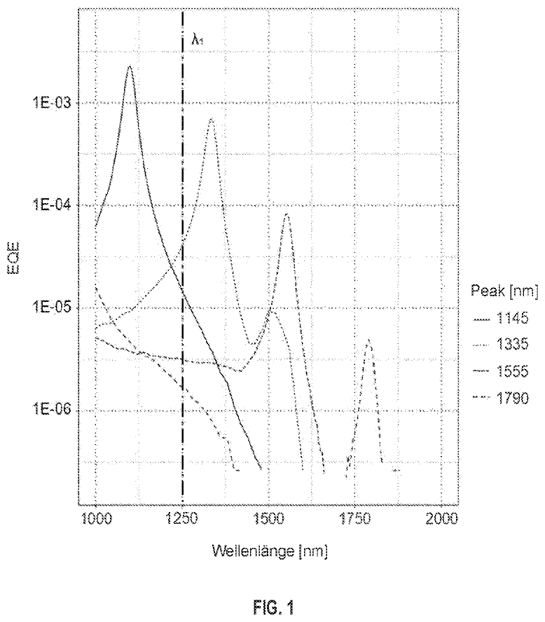

FIG. 1 shows measurement data y(x), in this case the EQE as a function of the wavelength of electromagnetic radiation, which were each recorded with one of the four channels of a measuring instrument in the entire range of x shown,

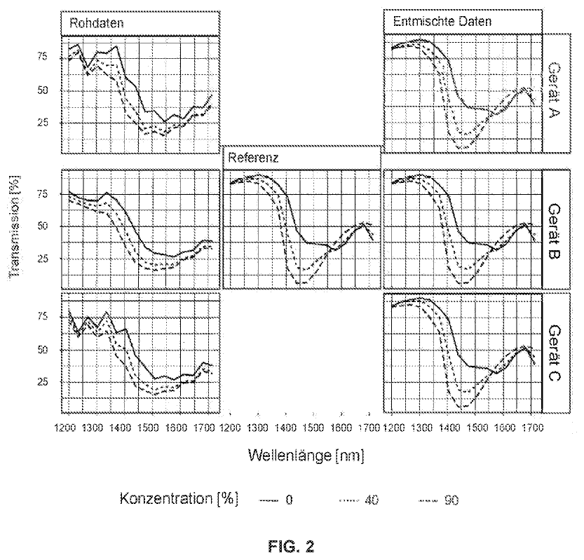

FIG. 2 shows a comparison of measurement curves generated with three different spectrometers before and after application of the method according to the invention, as well as with a reference measurement.

FIG. 1 shows the measured signal of four OPDs corresponding to the channels of a spectrometer, here the EQE as a function of the wavelength. In each of the OPDs, the photoactive layer is arranged in an optical microcavity so that the EQE of the OPD is maximized for electromagnetic waves with a wavelength that satisfies the resonance condition of the optical microcavity. An increase in EQE is also observed in an extended range around the specified resonance wavelength, so that a resonance peak has a comparatively large half-width. Furthermore, the EQE of OPDs with a high resonance wavelength is increased towards lower wavelengths, as can be seen in particular from the measurement data obtained with the OPD with a resonance wavelength of 1790 nm. When integrating the entire signal measured with an OPD over the wavelength range, the spectral characteristics of the individual OPDs are lost.

The method according to the invention is applied by selecting a number of wavelengths from the wavelength range shown, whereby the selected wavelengths do not have to be identical to a peak position. The wavelength λ1=1250 nm is taken as an example. The four OPDs or channels of the spectrometer contribute different shares to the overall signal at λ1: The OPD with a resonance wavelength of 1335 nm provides the largest share, while the OPD with a resonance wavelength of 1790 nm provides the smallest share. The proportions of the OPD or channels are described by coefficients. These method steps are repeated for the selected number of different wavelengths and the coefficient matrix is created. The method steps can also be carried out simultaneously for all selected wavelengths.

FIG. 2 shows a comparison of three measurement series generated with three different spectrometers (device) A (first row), B (second row) and C (third row), before (raw measurements, left column) and after (unmixed measurements, right column) application of the method according to the invention, as well as with a reference measurement of the samples (reference, middle column). The samples are a mixture of liquids with a water content of 0% (solid line), 40% (short dashed line) and 90% (long dashed line).

In the measurement curves shown in the left-hand column, where the method according to the invention was not used (raw measurements), it can be seen that a measurement curve consists of a number of individual values corresponding to the number of channels of the measuring instrument, between which linear interpolation was performed. A single value is generated by measuring the measurement data y(x), in the case shown the transmittance of electromagnetic radiation as a function of the wavelength of the electromagnetic radiation, with a channel of the spectrometer, integrating it over x and assigning the value of the integral for the transmittance to the resonance wavelength of the channel.

The measurement curves (unmixed measurements) shown in the right-hand column were generated by applying the method according to the invention to the measurement data y(x), here again the transmittance of electromagnetic radiation as a function of the wavelength of the electromagnetic radiation, whereby a value was generated at 16 additional wavelengths in each case using the method according to the invention.

The middle column shows reference curves for the three samples, which were measured using a high-resolution laboratory spectrometer, whereby only measured values at 16 wavelengths are shown here as well for better comparison.

Although the measurement curves generated on the same sample with different spectrometers show essentially the same profile and also qualitatively reflect the profile of the corresponding reference curve, they differ quantitatively, sometimes significantly (e.g. at a wavelength of about 1240 nm), and in particular the measurement curves generated with spectrometers A and C show artifacts.

After application of the method according to the invention, the measurement curves generated on the same sample with different spectrometers deviate only slightly from each other and from the corresponding reference curve. The isosbestic point of the measurement curves is also reproduced. Accordingly, the calibration transfer between the measurement curves and the application of chemometric models, which were created on the reference curve, for example, to the measurement curves can be significantly simplified with the aid of the method according to the invention.

1. A method for analyzing a sample from data generated by a measuring instrument divided into N channels, comprising at least the following method steps:
i. acquiring measurement data y(x) with at least one set of the N channels of the measuring instrument in a range of x overlapping between the selected channels;
ii. selecting a value xⱼ from the overlapping range of x;
iii. determining coefficients quantifying the respective share of the selected channels in the total response yₜₒₜ(xⱼ) recorded at xⱼ;
iv. repeating steps ii. and iii. for M values {x_{j,m}}ₘ₌₁^{M}.

2. The method according to claim 1, wherein the following method step is performed after method step iv.:
v. creating the coefficient matrix containing the coefficients determined in steps iii. and iv. for unmixing the shares of the selected channels in the total response.

3. The method according to claim 1, wherein M=N.

4. A computer-implemented method for analyzing a sample from data generated by a measuring instrument divided into N channels, comprising at least the following method steps:
a. acquiring measurement data y(x) with at least one set of the N channels of the measuring instrument in a range of x overlapping between the selected channels;
b. selecting a value xⱼ from the overlapping range of x;
c. determining coefficients quantifying the respective share of the selected channels in the total response yₜₒₜ(xⱼ) recorded at xⱼ;
d. repeating steps ii. and iii. for M values {x_{j,m}}ₘ₌₁^{M}.

5. The computer-implemented method according to claim 4, wherein the following method step is performed after method step d.:
e. creating the coefficient matrix containing the coefficients determined in steps c. and d. for unmixing the shares of the selected channels in the total response.

6. A data processing apparatus comprising means for carrying out the computer-implemented method according to claim 4.

7. A computer program product comprising instructions which, when the program is executed by a computer, cause the computer to perform the method according to claim 4.

8. A system for analyzing a sample, comprising a measuring instrument divided into N channels for acquiring data of the sample and a processor connected to the measuring instrument via a communication link, wherein the system performs the method for analyzing a sample from data according to claim 1.

9. The system according to claim 8, wherein the measuring instrument is a spectrometer.

10. (canceled)
